(19) United States
(12) Patent Application Publication
(10) Pub. No.: US 2007/0281844 A1
(43) Pub. Date: Dec. 6, 2007

(54) Cup Rim Unroller

(76) Inventor: Shaun Shulba, Abbotsford (CA)

Correspondence Address: QUICKPATENTS, INC., 32861 CALLE PERFECTO, SUITE A, SAN JUAN CAPISTRANO, CA, 92675, US

(21) Appl. No.: 11/422,288

(22) Filed: Jun. 5, 2006

(51) Int. Cl. B31B 1/00

(52) U.S. Cl. 493/158

(57) ABSTRACT

A tool for unfurling a rolled rim of a paperboard cup is disclosed. The tool comprises a rigid elongated member having a front side, a back side, and, preferably, four peripheral edges. One portion of the elongated member is rolled into a semi-spiral hook which is generally spiraled about a hook axis which is orthogonal to—but preferably does not intersect—a longitudinal axis of the elongated member. The hook axis is slightly curved to match a curvature of the rolled rim of the paperboard cup. An aperture is included through the elongated member at a lower end thereof. In use, the tool is grasped by a hand of a user, and the hook is inserted under the rolled rim of the paperboard cup. The tool is then pulled upward away from the cup to unfurl the rolled rim. The tool facilitates the unrolling of the rolled rim of the paperboard cup to reveal any writing or markings previously hidden within the rolled rim.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to hand tools, and more particularly to a hand tool for unrolling the rim of a disposable paperboard cup.

### DISCUSSION OF RELATED ART

Certain consumer contests, promotions and giveaways incorporate a hidden coupon, lottery number, or other indicia hidden in the rolled rim of a paperboard cup. It is not possible to see this hidden indicia until the rim is unrolled, and thus such promotions encourage consumers to purchase a beverage in such a cup in order to participate in the promotion or giveaway.

It is often difficult to unroll the rolled rim of such a cup manually. Such rolled rims are tightly packed and it is easy to bend-back a fingernail painfully or experience some other form of discomfort while trying to unroll such a rolled rim manually. Keys or other convenient tools are unsuitable for such a task as any tool used for such a purpose must be able to fit under the rim and be rigid enough to unroll the rim without slipping off.

One tool created for such a use, disclosed in Canadian Patent 2354968 to Sheridan on Jan. 30, 2003, teaches a clipper device that cuts the rim of the paper cup, which facilitates the revealing of the hidden indicia. However, such a device makes it only slightly easier to unroll the rim, the rim often still being difficult to unfurl even after being cut in two places, particularly for elderly or handicapped users. Further, with such a device it is easy to inadvertently cut through the indicia itself, possibly causing confusion or even refusal when attempting to redeem the coupon. Further, such a device is not easy to store conveniently and is relatively expensive to manufacture. Still further, after repeated use, the blade of such a device will become dull, making it difficult to use.

Therefore, there is a need for an inexpensive, easy-to-use, and easy-to-store apparatus that will conveniently facilitate the unfurling of a rolled rim of a paperboard cup. Such a needed device would not wear-out or become dull and difficult to use, even with many successive uses. The present invention accomplishes these objectives.

### SUMMARY OF THE INVENTION

The present device is a tool for unfurling a rolled rim of a paperboard cup. The tool comprises a rigid elongated member having a front side, a back side, and, preferably, four peripheral edges. One portion of the elongated member, preferably at an upper end thereof, is rolled into a semi-spiral hook. The hook is generally spiraled about a hook axis which is orthogonal to—but preferably does not intersect—a longitudinal axis of the elongated member. The hook axis is preferably slightly curved to match a curvature of the rolled rim of the paperboard cup, so that the hook contacts the rolled rim along a substantial length of the hook.

An aperture is preferably included through the elongated member at a lower end thereof. The aperture allows the tool to be hung on a nail, hook, or the like for convenient storage. Alternately, the device may include a magnet attached to the back side thereof for storing on a refrigerator or other magnetically-attractive surface.

In use, the tool is grasped by a hand of a user, and the hook is inserted under the rolled rim of the paperboard cup. The tool is then pulled upward away from the cup to unfurl the rolled rim. The user may pull upward more on one side of the elongated member than the other side to facilitate the unfurling of the rolled rim, or the user may pull straight up, parallel to the longitudinal axis of the cup. With either method, the tool facilitates the unrolling of the rolled rim of the paperboard cup to reveal any writing or markings previously hidden within the rolled rim.

Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a front elevational view of the invention;

FIG. 2A is a cross-sectional view of the invention, taken generally along lines 2A-2A of FIG. 1;

FIG. 2B is a cross-sectional view of the invention, taken generally along lines 2B-2B of FIG. 1;

FIG. 3 is a perspective view of the invention, illustrating a paperboard cup with a rolled rim and the tool of the present invention;

FIG. 4 is a perspective view of the invention, illustrating the tool of the present invention positioned to begin unfurling the rolled rim of the paperboard cup;

FIG. 5 is a perspective view of the invention, illustrating a user's hand positioned with the tool of the present invention to begin unfurling the rolled rim of the paperboard cup; and

FIG. 6 is a perspective view of the invention, illustrating the rim of the paperboard cup as unfurled after the tool of the present invention has been used on thereon.

### DETAILED DESCRIPTION OF THE PREFERRED EMBODIMENT

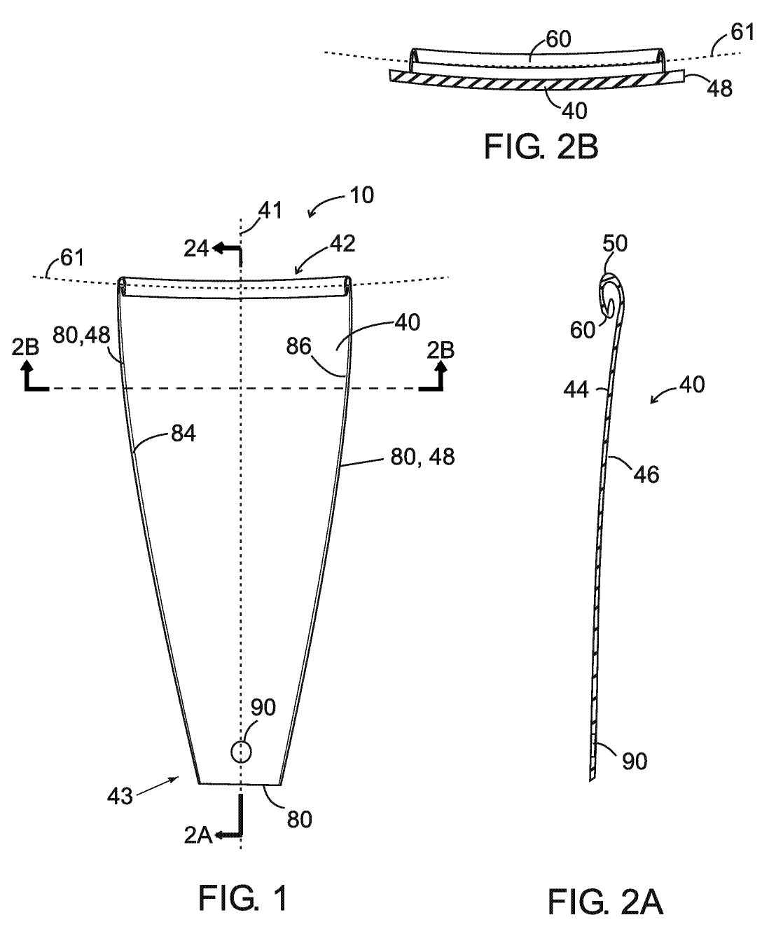

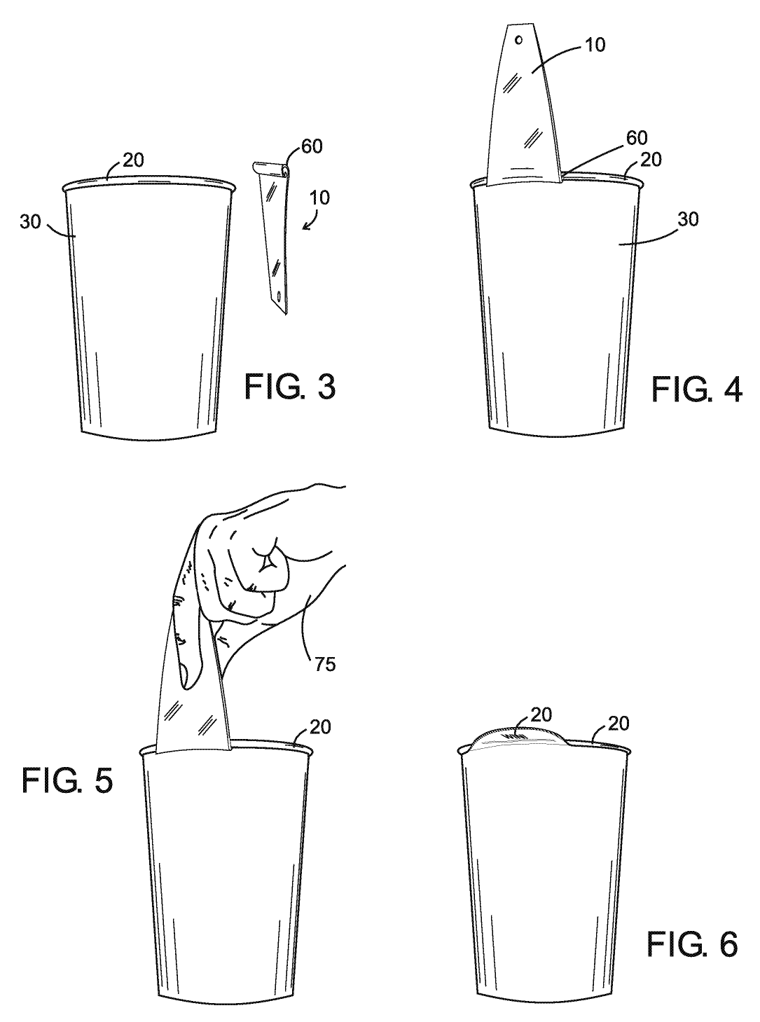

FIGS. 1 and 4 illustrate a tool 10 for unfurling a rolled rim 20 of a paperboard cup 30. The tool 10 comprises a rigid elongated member 40 having a front side 44, a back side 46, and at least one peripheral edge 48, the elongated member 40 further including a longitudinal axis 41. Preferably the tool 10 includes four peripheral edges 48, as illustrated in FIG. 1. Alternately, however, the tool 10 may include two or three peripheral edges 48 (not shown).

One portion 50 of the elongated member 40, preferably at an upper end 42 thereof, is rolled into a semi-spiral hook 60 (FIGS. 1, 2A and 2B). The hook 60 is generally spiraled about a hook axis 61 which is orthogonal to—but preferably does not intersect—the longitudinal axis 41 of the elongated member 40. As illustrated in FIG. 2B, the hook axis 61 is preferably slightly curved to match a curvature of the rolled rim 20 of the paperboard cup 30, so that the hook 60 contacts the rolled rim 20 along a substantial length of the hook 60 (FIGS. 4 and 5).

Further, the elongated member 40 is preferably slightly curved in cross-section from one side edge 84 to another side edge 86 (FIG. 2B). Preferably the elongated member 40 is made from a rigid material, such as metal, a strong plastic, or a strong wood material material. Preferably the ratio of length to width of the elongated member 40 is approximately three to one. When made from a metal material, the tool 10 may be stamped from a sheet of rigid metal material, whereupon the hook 60 may be roll-formed.

An aperture 90 is preferably included through the elongated member 40, as illustrated in FIGS. 1 and 2A, at a lower end 43 thereof The aperture 90 allows the tool 10 to be hung on a nail, hook, or the like for convenient storage (not shown). Alternately, the device may include a magnet attached to the back side 46 thereof for storing on a refrigerator or other magnetically-attractive surface (not shown).

In use, the tool is grasped by a hand 75 of a user 70, and the hook 60 is inserted under the rolled rim 20 of the paperboard cup 30. The tool 10 is then pulled upward away from the cup 30 to unfurl the rolled rim 20 (FIGS. 5 and 6). The user may pull upward more on one side of the elongated member 40 than the other side to facilitate the unfurling of the rolled rim 20, or the user may pull straight up, parallel to the longitudinal axis of the cup (not shown). With either method, the tool 10 facilitates the unrolling of the rolled rim 20 of the paperboard cup 30 to reveal any indicia 25 previously hidden within the rolled rim 20.

While a particular form of the invention has been illustrated and described, it will be apparent that various modifications can be made without departing from the spirit and scope of the invention. For example, the exact shape of the elongated member may be changed in any number of ways while not affecting the effectiveness of the tool 10. Accordingly, it is not intended that the invention be limited, except as by the appended claims.

What is claimed is:

1. A tool for unfurling a rolled rim of a paperboard cup, comprising:
a rigid elongated member having a front side, a back side, and at least one peripheral edge, the elongated member having a longitudinal axis, one portion of the elongated member rolled into a semi-spiral hook, the hook being generally spiraled about a hook axis generally orthogonal to the longitudinal axis of the elongated member;
whereby with the tool grasped by a hand of a user, the hook may be inserted under the rolled rim of the paperboard cup and the tool may be pulled upward away from the cup to unfurl the rolled rim.

2. The tool of claim 1 wherein the hook axis is slightly curved to match a curvature of the rolled rim of the paperboard cup, whereby the hook may contact the rolled rim of the cup along a substantial length of the hook.

3. The tool of claim 1 wherein the hook axis does not intercept the longitudinal axis of the elongated member.

4. The tool of claim 1 wherein the at least one peripheral edge is exactly three peripheral side edges.

5. The tool of claim 1 wherein the at least one peripheral edge is exactly four peripheral side edges.

6. The tool of claim 1 wherein the elongated member further includes an aperture therethrough, the hook being located at an upper end of the elongated member and the aperture being located at a lower end of the elongated member.

7. The tool of claim 5 wherein the elongated member is slightly curved in cross-section from one side edge to another side edge.

8. The tool of claim 4 wherein the elongated member is slightly curved in cross-section from one side edge to another side edge.

9. The tool of claim 1 wherein the elongated member is made from a rigid metal material.

10. The tool of claim 1 wherein the elongated member is made from a rigid plastic material.

11. The tool of claim 1 wherein the elongated member is made from a rigid wood material.

12. The tool of claim 1 wherein the ratio of length to width of the elongated member is approximately three to one.
